(19) United States
(12) Patent Application Publication
(10) Pub. No.: US 2026/0216706 A1
(43) Pub. Date: Jul. 30, 2026

(54) SELECTING AND MODIFICATION METHOD OF COAL-BASED ACTIVATED CARBON SUITABLE FOR USE IN HIGH-GRAVITY DEVICE

(71) Applicants: Weizhou Jiao, Taiyuan City (CN); Cibin Wang, Taiyuan City (CN); Youzhi Liu, Taiyuan City (CN); Fuming Miao, Taiyuan City (CN); Yan Xue, Taiyuan City (CN); Tong Zhao, Taiyuan City (CN); Guisheng Qi, Taiyuan City (CN); Zhiguo Yuan, Taiyuan City (CN); Qiang Guo, Taiyuan City (CN); Chao Zhang, Taiyuan City (CN)

(72) Inventors: Weizhou Jiao, Taiyuan City (CN); Cibin Wang, Taiyuan City (CN); Youzhi Liu, Taiyuan City (CN); Fuming Miao, Taiyuan City (CN); Yan Xue, Taiyuan City (CN); Tong Zhao, Taiyuan City (CN); Guisheng Qi, Taiyuan City (CN); Zhiguo Yuan, Taiyuan City (CN); Qiang Guo, Taiyuan City (CN); Chao Zhang, Taiyuan City (CN)

(21) Appl. No.: 19/404,703

(22) Filed: Dec. 1, 2025

(30) Foreign Application Priority Data
Jan. 24, 2025 (CN) 202510118603.X

(51) Int. Cl. B01J 23/889; B01J 21/18; B01J 23/75; B01J 35/40; B01J 35/51; B01J 37/02; B01J 37/06; B01J 37/08; C02F 1/72; C02F 1/78; C02F 101/34

(52) U.S. Cl. CPC B01J 23/8892; B01J 21/18; B01J 23/75; B01J 35/40; B01J 35/51; B01J 37/0205; B01J 37/0236; B01J 37/024; B01J 37/06; B01J 37/08; C02F 1/725; C02F 1/78; C02F 2101/345

(57) ABSTRACT

Provided is a selecting and modification method of a coal-based activated carbon suitable for use in a high-gravity device. Different activated carbons are compared for attrition rate and stability in a high-gravity device through experiments. Additionally, loading modification is conducted on each of the different activated carbons, and resulting activated carbon catalysts are compared for catalytic activity.

### CROSS REFERENCE TO RELATED APPLICATION

This patent application claims the benefit and priority of Chinese Patent Application No. 202510118603.X filed with the China National Intellectual Property Administration on Jan. 24, 2025, the disclosure of which is incorporated by reference herein in its entirety as part of the present application.

### TECHNICAL FIELD

The present disclosure belongs to the technical field of preparation of activated carbon catalysts, and specifically relates to a selecting and modification method of a coal-based activated carbon suitable for use in a high-gravity device.

### BACKGROUND

Coal, as the primary energy source in China, accounts for a high proportion in fossil energy resources. Coal is the energy source with the strongest capacity for stabilizing the economy and ensuring the self-sufficiency of energy. However, as the modern coal chemical technology is increasingly mature, the similarity problem of coal-derived end products has become prominent, resulting in the continuous decline in prices of coal-derived end products. The high-value utilization of coal can be achieved through the development of high-end carbon materials.

Coal-based activated carbon has a large specific surface area and a tunable pore structure, and is extensively used in fields such as adsorption catalysis. Main types of activated carbon include spherical activated carbon, cylindrical activated carbon, and amorphous activated carbon. These three types of activated carbon are widely used as adsorbents and catalyst supports in the field of wastewater treatment.

The patent CN109382107A discloses an activated carbon-supported metal oxide as an ozone oxidation catalyst, which is prepared through incipient wetness impregnation and high-temperature calcination. When used in the ozone catalytic oxidation of industrial wastewater, the ozone oxidation catalyst can efficiently remove non-biodegradable soluble chemical oxygen demand (nbsCOD) from the wastewater. After 60 min of the ozone catalytic oxidation, a removal rate of nbsCOD can be as high as 80%, which is 50% or more higher than a chemical oxygen demand (COD) removal rate achieved by the ozone contact oxidation. However, the preparation of activated carbon catalysts by the incipient wetness impregnation is time-consuming and leads to poor dispersion of active metal components, which significantly impairs the catalytic performance of these activated carbon catalysts. The patent CN115007148A discloses a process for preparing a catalyst by loading α-FeOOH on a surface of activated carbon through co-precipitation. However, this process is relatively complex, and the catalyst demonstrates low catalytic activity. The patent CN114308113A discloses a method for preparation of a catalyst by loading an active component through magnetic stirring and calcination on alkali-modified powdered activated carbon as a support and using a molecular sieve as an additive, and use of the catalyst in the advanced treatment of low-concentration refractory chemical wastewater. Effluent water produced after the low-concentration refractory chemical wastewater (COD=80 mg/L to 100 mg/L) is treated with this catalyst can have COD of less than or equal to 50 mg/L. However, due to a small particle size, this activated carbon catalyst is not easily recycled, which significantly limits the extensive application of this activated carbon catalyst.

Traditional preparation methods for catalysts are relatively basic, and often require a cumbersome time-consuming process. Moreover, catalysts prepared by the traditional preparation methods exhibit poor catalytic activity. This is because impregnation solutions used in the traditional preparation methods have poor fluidity, resulting in slow diffusion and inadequate dispersion of an active component on a surface of a support. These defects can be overcome by using a high-gravity technology to prepare catalysts. The principle of the high-gravity technology is as follows: The incoming precursor solution is sheared into fine liquid filaments, droplets, and liquid films through the high-speed rotation of a high-gravity rotating packed bed. This design enhances the fluidity of the precursor solution, accelerates the refreshing of a liquid on a surface of a support, and increases the interfacial contact area, thereby remarkably improving the mass transfer rate between solid and liquid phases. In a catalyst prepared by the high-gravity technology, a large amount of an active component is uniformly loaded.

The patent CN113893874B discloses a method for preparation of a supported Mn-based catalyst using a ZSM-5 catalyst support as a packing in a rotating packed bed and nitrates of Mn and Fe as an impregnation solution, and use of the supported Mn-based catalyst in the degradation of nitrobenzene. The patent CN116328762A discloses a method for preparation of a carbon-based metal catalyst, including: a carbon material is dissolved and dispersed in a water and/or alcohol solvent to produce a carbon material dispersion; the carbon material dispersion and a metal complex suspension are fed into a high-gravity rotating packed bed and circulate in the high-gravity rotating packed bed to allow a reaction for 5 min to 10 min so as to produce an active metal complex-loaded carbon material suspension; the active metal complex-loaded carbon material suspension is then oven-dried to produce a carbon-based metal catalyst precursor; and the carbon-based metal catalyst precursor is calcined at a high temperature for reduction under nitrogen protection to produce the carbon-based metal catalyst. The activated carbon catalyst prepared by the high-gravity technology in this patent exhibits high activity and excellent dispersibility of an active component. However, this catalyst has a small particle size, and thus is not easily recycled. Additionally, given the unique reaction environment of the high-gravity rotating packed bed, the continuous progression of the reaction will lead to the heavy attrition of the catalyst. Therefore, the selection of an activated carbon support suitable for use in a high-gravity device is crucial for enhancing both the activity and reusability of an activated carbon catalyst.

### SUMMARY

An object of the present disclosure is to provide a selecting and modification method for a coal-based activated carbon suitable for use in a high-gravity device. In the present disclosure, various performance parameters of different activated carbons are tested, and the coal-based activated carbon suitable for use in the high-gravity device is selected and then subjected to loading modification to prepare a highly-active and highly-stable activated carbon catalyst in the high-gravity device.

The present disclosure provides the following technical solutions:

A selecting and modification method of a coal-based activated carbon suitable for use in a high-gravity device is provided, wherein the method includes the following steps:
S1, washing six different coal-based activated carbons with deionized water, oven-drying, and cooling; conducting a reaction under a high-gravity factor by using each of cooled coal-based activated carbons as a first packing in a high-gravity rotating packed bed and water as a first impregnation solution; and determining attrition rates of each of the cooled coal-based activated carbons, and selecting the coal-based activated carbon that guarantees high stability of an obtained activated carbon catalyst;
S2, washing the six different coal-based activated carbons with deionized water, oven-drying, and cooling; immersing each of resulting cooled coal-based activated carbons in a second impregnation solution having 0.1 mol/L of a cobalt salt, and conducting loading modification by a first high-temperature calcination to load the cobalt salt on a surface of each of the resulting cooled coal-based activated carbons to produce different activated carbon catalysts, respectively; and investigating catalytic activities of the different activated carbon catalysts in an aeration device, and selecting an activated carbon catalyst with a maximum catalytic activity; and
S3, placing a resulting selected coal-based activated carbon as a second packing in the high-gravity rotating packed bed; preparing a precursor solution with a total concentration of 0.1 mol/L and a cobalt-to-manganese ratio of 3:1 as a third impregnation solution, and placing the third impregnation solution in a liquid storage tank; delivering the third impregnation solution from the liquid storage tank into an inner chamber of the high-gravity rotating packed bed by a circulation pump, spraying the third impregnation solution uniformly on an inner edge of an activated carbon support bed layer by a liquid distributor, such that the third impregnation solution is in full contact with the resulting selected coal-based activated carbon for impregnation radially in a spray form under a high-speed centrifugal force, returning the third impregnation solution to the liquid storage tank through a lower outlet of the activated carbon support bed layer, and conducting cyclic impregnation; and reacting for a specified period, oven-drying, and conducting a second high-temperature calcination to enable loading of an active component.

Further, the six different coal-based activated carbons include a 2 mm spherical activated carbon, a 4 mm spherical activated carbon, a 5 mm spherical activated carbon, a 7 mm spherical activated carbon, a 5 mm cylindrical activated carbon, and a 5 mesh to 30 mesh amorphous activated carbon.

Further, the high-gravity factor in the S1 is in a range of 0 to 50.

Further, the first high-temperature calcination in the S2 and the second high-temperature calcination in the S3 are each conducted by raising a temperature at a heating rate of 5° C./min to 500° C., and calcining at the temperature for 5 h.

Further, a parameter for the high-gravity rotating packed bed is as follows: a rotator has a ratio of inner diameter:outer diameter:height of 1:3:2.

Attrition rates of different activated carbons in a high-gravity environment are calculated based on mass changes before and after reactions of the activated carbons.

A cobalt salt is used as an active component for an activated carbon catalyst. Loading conditions and catalytic activities of different activated carbon catalysts are preliminarily determined through the loading of the cobalt salt.

Activated carbons with different shapes and particle sizes may undergo varying wear degrees in a rotating packed bed, and a wear degree primarily depends on a frictional force experienced during a rotation and a hardness of an activated carbon. Thus, a wear rate of an activated carbon is considered as the prerequisite to ensuring the stability and high activity of an activated carbon catalyst.

Different activated carbons exhibit different adsorption and catalytic properties due to distinct pore structure characteristics, including a pore size, a pore volume, and a pore distribution. These pore structure characteristics affect the dispersion of an active component on a surface of an activated carbon, thereby affecting an activity of an activated carbon catalyst.

The preparation of an activated carbon catalyst essentially relies on the adsorption of an active component by an activated carbon and the subsequent fixation of the active component on a surface of the activated carbon through high-temperature calcination. The conventional preparation of an activated carbon catalyst is primarily based on the adsorption of an activated carbon. However, due to the poor fluidity of an impregnation solution, the conventional preparation of an activated carbon catalyst is time-consuming and leads to inadequate dispersion of an active component. In a high-gravity method to prepare an activated carbon catalyst, a packing rotating at a high speed can shear an impregnation solution into extremely-thin liquid films and fine mists and droplets, which can accelerate the refreshing of a liquid on a surface of an activated carbon, increase the interfacial contact area, and intensify the solid-liquid mass transfer. As a result, the adsorption equilibrium can be achieved rapidly, and an active component can be uniformly loaded to achieve the preparation of the catalyst.

Some embodiments of the present disclosure have the following beneficial effects:

The present disclosure enables selecting of a coal-based activated carbon suitable for use in a high-gravity device and provides a method for preparing an activated carbon catalyst. The selected coal-based activated carbon not only meets the high-strength requirement under a high-gravity environment, but also enables the uniform loading of an active component, resulting in high catalytic activity. Further, using the high-gravity method for preparing an activated carbon catalyst offers advantages such as simple preparation, short preparation time, high catalyst activity, and ease of scalability.

### BRIEF DESCRIPTION OF THE DRAWINGS

FIG. 1 is a schematic diagram of a high-gravity reaction device according to an embodiment in the present disclosure;

FIG. 2 shows photographs of different coal-based activated carbons;

FIG. 3 shows attrition rates of different coal-based activated carbons in a high-gravity environment, where an x-coordinate represents a type of a coal-based activated carbon and a y-coordinate represents attrition rate of the coal-based activated carbon;

FIG. 4 is a schematic diagram of a reaction device to test catalytic activities of different activated carbon catalysts according to an embodiment in the present disclosure;

FIG. 5 shows the comparison of catalytic activities of different modified coal-based activated carbons, where an x-coordinate represents a type of a modified coal-based activated carbon, a y-coordinate represents a mineralization rate of phenol, and a catalytic activity of a catalyst is reflected by the mineralization rate of phenol;

FIG. 6 shows the comparison of catalytic activity between a catalyst prepared by a high-gravity method and a catalyst prepared by a traditional method;

FIG. 7 shows the comparison of uniformity between the catalyst prepared by the high-gravity method and the catalyst prepared by the traditional method; and

FIG. 8 shows the comparison of reusability between the catalyst prepared by the high-gravity method and the catalyst prepared by the traditional method.

In the figures, 1—motor; 2—rotating packed bed; 3—rotameter; 4—water pump; 5—liquid storage tank; 6—oxygen cylinder; 7—ozone generator; 8—gas flow meter; 9—ozone concentration detector; 10—aeration reaction device; 11—catalyst; and 12—tail gas absorption device.

### DETAILED DESCRIPTION OF THE EMBODIMENTS

To make the design solutions and ideas of the present disclosure clear, the present disclosure will be further described below with reference to examples. The described examples are merely some rather than all examples of the present disclosure. All other examples obtained by those of ordinary skill in the art based on the examples of the present disclosure without creative efforts shall fall within the scope of the present disclosure.

### Example 1

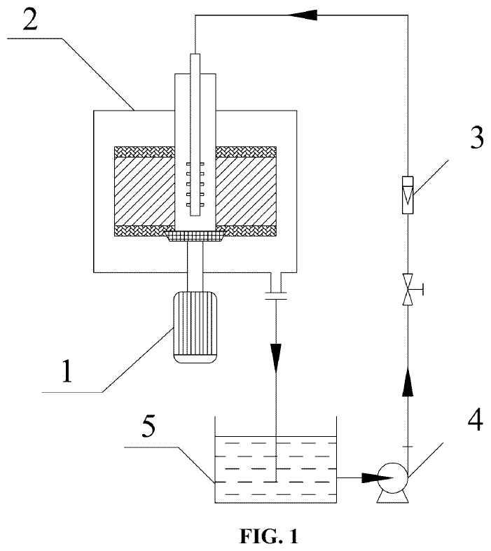

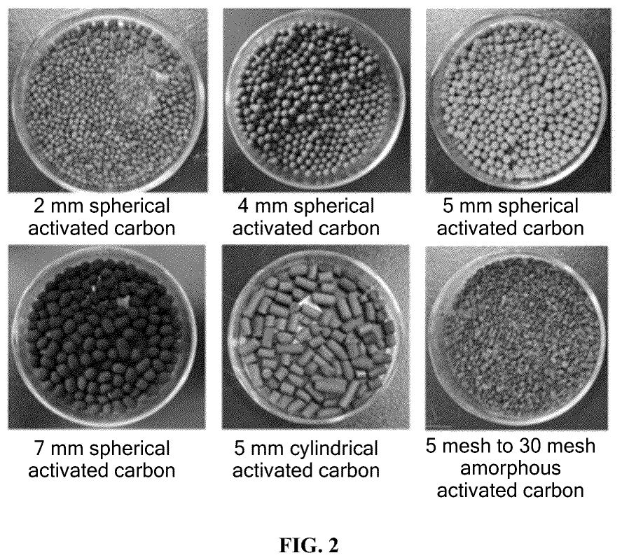

A process to detect attrition rates of different coal-based activated carbons in a high-gravity environment was conducted in the high-gravity reaction device as shown in FIG. 1 of the present disclosure. Different activated carbons were used as a first packing in a high-gravity rotating packed bed, respectively, and water was used as a first impregnation solution. A resulting system was subjected to a reaction for several hours, and mass changes of the different activated carbons before and after the reaction were measured to calculate attrition rates of the different activated carbons.

A specific detection process was conducted as follows:

Six different coal-based activated carbons (being a 2 mm spherical activated carbon, a 4 mm spherical activated carbon, a 5 mm spherical activated carbon, a 7 mm spherical activated carbon, a 5 mm cylindrical activated carbon, and a 5 mesh to 30 mesh amorphous activated carbon, which were denoted as AC1, AC2, AC3, AC4, AC5, and AC6, respectively) were each washed with deionized water five times to remove residual impurities and dust from a surface of each of the coal-based activated carbons, then dried in an oven at 110° C. for 12 h, cooled, and stored at a sealed state for later use. A specified mass of each of pretreated activated carbons was weighed and fed into a rotating packed bed to serve as a first packing. Water was fed into a liquid storage tank. A motor was adjusted to achieve a high-gravity factor of 50 for the first packing. The water in the liquid storage tank was pumped by a water pump into the rotating packed bed at a flow rate of 100 L/h. The water was sprayed onto the first packing. The water was thrown onto an inner wall under a centrifugal force, then flowed along the inner wall to a lower outlet, and was finally returned to the liquid storage tank, resulting in a circulation system. After a reaction was conducted for 2 h, a resulting activated carbon was taken out, dried in an oven at 110° C. for 12 h, cooled, and measured for a mass. The mass was compared with a mass before the reaction to calculate attrition rate of each of the coal-based activated carbons.

### Example 2

To evaluate catalytic activities of different activated carbon catalysts, loading modification was conducted on each of six different activated carbons. Resulting activated carbon catalysts were then used in an experiment of catalytic ozone degradation of phenol. A catalytic activity of a catalyst was reflected by a mineralization rate of phenol. In this way, the catalytic activities of the different activated carbon catalysts were determined.

A specific experimental process was conducted as follows:

Six different coal-based activated carbons (being a 2 mm spherical activated carbon, a 4 mm spherical activated carbon, a 5 mm spherical activated carbon, a 7 mm spherical activated carbon, a 5 mm cylindrical activated carbon, and a 5 mesh to 30 mesh amorphous activated carbon) were each washed with deionized water five times to remove the residual impurities and dust from a surface of each activated carbon, then dried in an oven at 110° C. for 6 h, cooled, and stored at a sealed state for later use. A second impregnation solution with a concentration of 0.1 mol/L of a cobalt salt was prepared and added to a conical flask. Different activated carbons were each taken at a specified mass, added to the conical flask, and impregnated for a specified period of time. Impregnated activated carbon particles were dried in an oven at 110° C. for 12 h, then calcined in a tube furnace under nitrogen protection, and cooled to produce different activated carbon catalysts C1, C2, C3, C4, C5, and C6.

A device for testing a catalytic activity of an activated carbon catalyst is shown in FIG. 4. The prepared catalysts were each used in an experiment of catalytic ozone degradation of phenol to investigate catalytic activities of the catalysts. A reaction was carried out in a 500 mL aeration reaction device. An aerator was provided at a bottom of a measuring cylinder. Bubbles were continuously generated from ozone through the aerator. 500 mL of simulated wastewater including phenol at a concentration of 100 mg/L and 2 g/L of an activated carbon catalyst were fed into the aeration reaction device. An inlet ozone concentration was 40 mg/L, and a reaction time was 30 min. After the reaction was completed, the residual ozone was absorbed by a KI solution.

### Example 3

A process of preparation of an activated carbon catalyst by a high-gravity method was conducted in the high-gravity reaction device as shown in FIG. 1. The selected activated carbon was further subjected to a loading modification to produce a highly-active and highly-stable activated carbon catalyst.

A specific experimental process was conducted as follows:

The selected activated carbon was washed with deionized water five times to remove the residual impurities and dust from a surface of the activated carbon, then dried in an oven at 110° C. for 6 h, cooled, and stored at a sealed state for later use. A specified amount of granular activated carbon (GAC) was weighed and used as a second packing in a rotating packed bed. A metal salt solution with a total concentration of 0.1 mol/L and a cobalt-to-manganese ratio of 3:1 was added to a liquid storage tank. The metal salt solution was sprayed at an inflow rate of 80 L/h by a liquid distributor on the entire second packing to ensure the full contact with the GAC. A reaction device is shown in FIG. 1. A solution left after a reaction was returned to the liquid storage tank for recycling. After 40 min of impregnation, drying in an oven and calcination in a tube furnace were conducted according to the same methods and conditions as above. A calcination product was cooled to produce an activated carbon catalyst C7 prepared by a high-gravity rotating packed bed.

### Comparative Example 1

To evaluate the catalytic activity and stability of the activated carbon catalyst prepared by the high-gravity method, an activated carbon catalyst was further prepared by a traditional impregnation method.

A specific experimental process was conducted as follows:

The selected activated carbon was washed with deionized water five times to remove the residual impurities and dust from a surface of the activated carbon, then dried in an oven at 110° C. for 6 h, cooled, and stored at a sealed state for later use. A metal salt solution with a total concentration of 0.1 mol/L and a cobalt-to-manganese ratio of 3:1 was prepared and added to a conical flask. A specified mass of an activated carbon was taken, added to the conical flask, and impregnated for a specified period of time. Impregnated activated carbon particles were dried in an oven at 110° C. for 12 h, then calcined in a tube furnace under nitrogen protection, and cooled to produce an activated carbon catalyst C8.

TABLE 1
Physical parameters of different coal-based activated carbons

| | | Specific | | | | | |
|---|---|---|---|---|---|---|---|
| | | surface | Iodine | | Pore | Pore | Floating |
| | | area | value | Strength | size | volume | rate |
| No. | Type | (m²/g) | (mg/g) | (%) | (nm) | (cm³/g) | (%) |
| C1 | 2 mm spherical | 1095 | 1004 | 98.47% | 2.27 | 0.64 | 0.3 |
| C2 | 4 mm spherical | 1025 | 950 | 97.81% | 2.68 | 0.51 | 0.35 |
| C3 | 5 mm spherical | 950 | 923 | 97.64% | 3.15 | 0.49 | 0.26 |
| C4 | 7 mm spherical | 890 | 862 | 96.84% | 3.65 | 0.46 | 0.20 |
| C5 | 5 mm cylindrical | 800 | 902 | 95.15% | 3.15 | 0.56 | 0.28 |
| C6 | 5 mesh to 30 | 1056 | 1013 | 93.48% | 2.63 | 0.7 | 0.15 |
| | mesh amorphous | | | | | | |

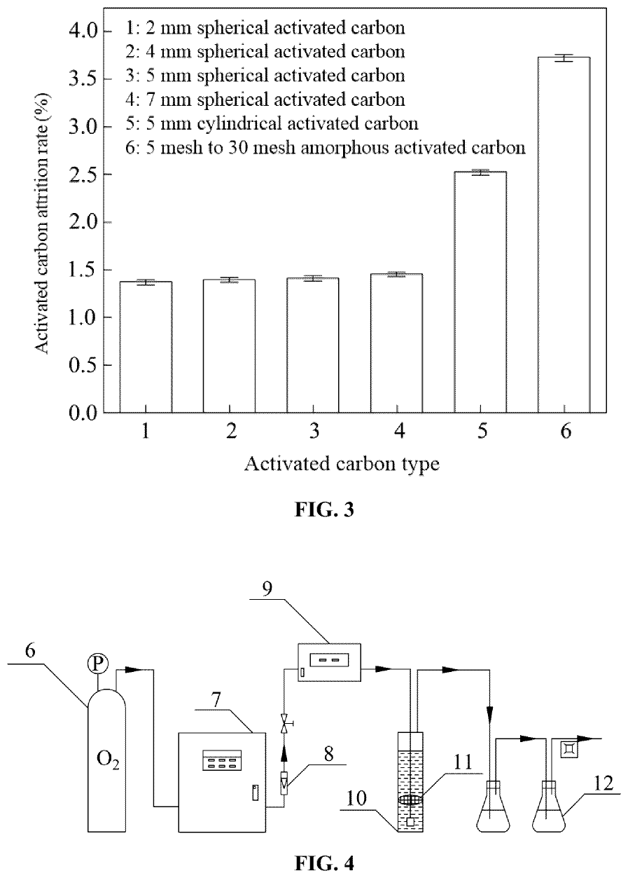

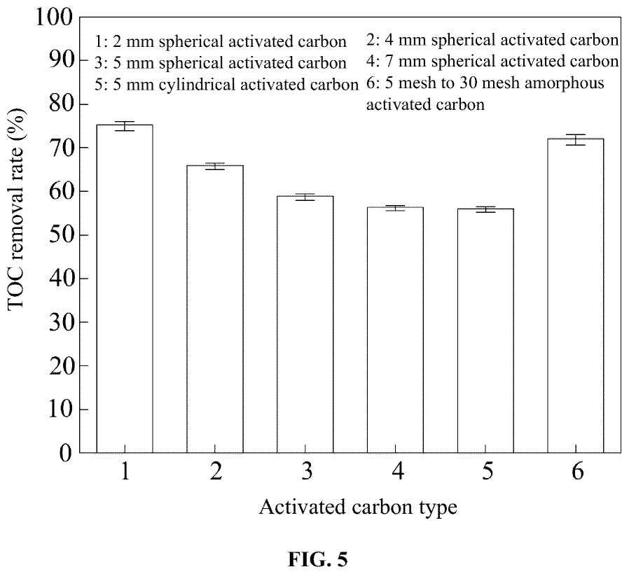

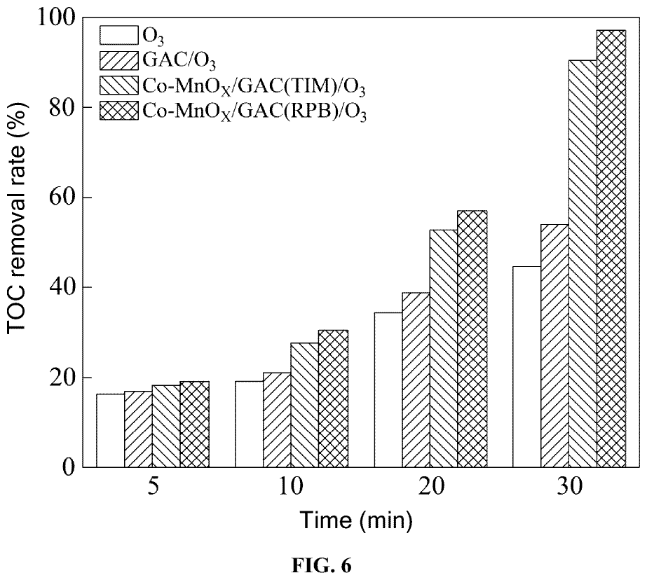

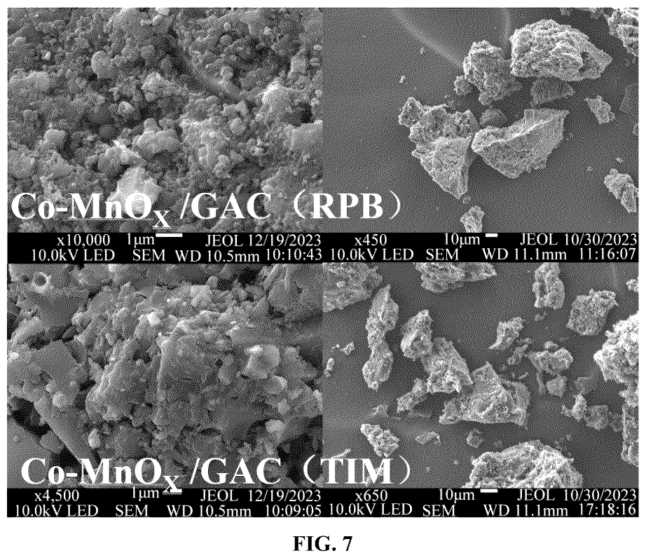

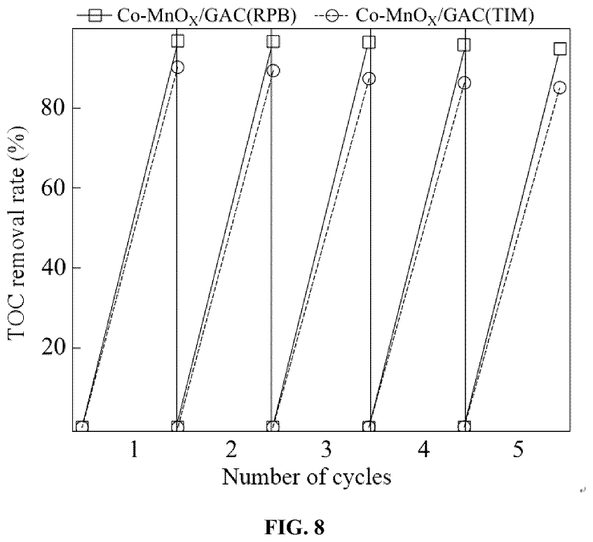

According to the physical parameters of various activated carbons in the table above and the wear rates of different activated carbons in FIG. 3, the spherical activated carbons have low wear rates and high mechanical strengths. Moreover, as shown in FIG. 5, the 4 mm, 5 mm, and 7 mm spherical activated carbon catalysts undergo low wear rates, but exhibit relatively-low catalytic activities. The amorphous activated carbon catalyst can achieve a total organic carbon (TOC) removal rate of 71% after being used in a reaction for 30 min, indicating a high catalytic activity. However, the amorphous activated carbon catalyst suffers from a high wear rate and poor stability. The 2 mm spherical activated carbon catalyst demonstrates a low wear rate and a superior catalytic activity, and can achieve a TOC removal rate of 74.3% after being used in a reaction for 30 min. Given the comprehensive consideration of stability and catalytic activities of activated carbons, the 2 mm spherical activated carbon is determined as the optimal coal-based activated carbon for a high-gravity device.

TABLE 2
Times, loads, leaching rates, and catalytic activities
of catalysts prepared by different methods

| | | Catalyst | | | |
|---|---|---|---|---|---|
| | | preparation | Load | Leaching | Catalytic |
| No. | Type | time (h) | (%) | rate (%) | activity (%) |
| C5 | Co—MnOx/GAC | 36 | 2.36 | 0.04 | 96.82 |
| | (TIM) | | | | |
| C6 | Co—MnOx/GAC | 1 | 2.02 | 0.09 | 90.2 |
| | (RPB) | | | | |

Two different catalysts Co—MnOₓ/GAC (RPB) and Co—MnOₓ/GAC (TIM) were prepared by the high-gravity method and the traditional impregnation method, respectively. The preparation of the catalyst by the high-gravity method involves a 98% shorter time, enables a 6.62% higher catalytic activity, a larger load, and a less attrition of an active component during a reaction than the preparation of the catalyst by the traditional method. It can be seen that the catalyst prepared by the high-gravity method demonstrates excellent stability, high reusability, and enhanced catalytic activity, indicating significant advantages.

The embodiments and ideas of the present disclosure are illustrated herein through three examples and one comparative example. The above content is solely intended to facilitate the comprehension of the core solutions and concepts of the present disclosure. The above are the illustrated embodiments of the present disclosure. It should be noted that various changes and modifications can be made by those skilled in the art to the present disclosure.

Any modification, equivalent replacement, and improvement made within the spirit and principle of the present disclosure or the direct use of the concepts and technical solutions of the present disclosure in other scenarios without modification shall fall within the scope of the present disclosure.

What is claimed is:

1. A selecting and modification method of a coal-based activated carbon suitable for use in a high-gravity device, wherein the selecting and modification method comprises the following steps:
S1, washing six different coal-based activated carbons with deionized water, oven-drying, and cooling; conducting a reaction under a high-gravity factor by using each of cooled coal-based activated carbons as a first packing in a high-gravity rotating packed bed and water as a first impregnation solution; and determining attrition rates of each of the cooled coal-based activated carbons, and selecting the coal-based activated carbon that guarantees high stability of an obtained activated carbon catalyst;
S2, washing the six different coal-based activated carbons with deionized water, oven-drying, and cooling; immersing each of resulting cooled coal-based activated carbons in a second impregnation solution having 0.1 mol/L of a cobalt salt, and conducting loading modification by a first high-temperature calcination to load the cobalt salt on a surface of each of the resulting cooled coal-based activated carbons to produce different activated carbon catalysts, respectively; and investigating catalytic activities of the different activated carbon catalysts in an aeration device, and selecting an activated carbon catalyst with a maximum catalytic activity; and
S3, placing a resulting selected coal-based activated carbon as a second packing in the high-gravity rotating packed bed; preparing a precursor solution with a total concentration of 0.1 mol/L and a cobalt-to-manganese ratio of 3:1 as a third impregnation solution, and placing the third impregnation solution in a liquid storage tank; delivering the third impregnation solution from the liquid storage tank into an inner chamber of the high-gravity rotating packed bed by a circulation pump, spraying the third impregnation solution uniformly on an inner edge of an activated carbon support bed layer by a liquid distributor, such that the third impregnation solution is in full contact with the resulting selected coal-based activated carbon for impregnation radially in a spray form under a high-speed centrifugal force, returning third the impregnation solution to the liquid storage tank through a lower outlet of the activated carbon support bed layer, and conducting cyclic impregnation; and reacting for a period of time, oven-drying, and conducting a second high-temperature calcination to enable loading of an active component.

2. The selecting and modification method of the coal-based activated carbon suitable for use in the high-gravity device of claim 1, wherein the six different coal-based activated carbons comprise a 2 mm spherical activated carbon, a 4 mm spherical activated carbon, a 5 mm spherical activated carbon, a 7 mm spherical activated carbon, a 5 mm cylindrical activated carbon, and a 5 mesh to 30 mesh amorphous activated carbon.

3. The selecting and modification method of the coal-based activated carbon suitable for use in the high-gravity device of claim 1, wherein the high-gravity factor in the S1 is in a range of 0 to 50.

4. The selecting and modification method of the coal-based activated carbon suitable for use in the high-gravity device of claim 1, wherein the first high-temperature calcination in the S2 and the second high-temperature calcination in the S3 are each conducted by raising a temperature at a heating rate of 5° C./min to 500° C., and calcining at the temperature for 5 h.

5. The selecting and modification method of the coal-based activated carbon suitable for use in the high-gravity device of claim 1, wherein a parameter for the high-gravity rotating packed bed is as follows: a rotator has a ratio of inner diameter:outer diameter:height of 1:3:2.
